(19) United States
(12) Patent Application Publication
(10) Pub. No.: US 2017/0087049 A1
(43) Pub. Date: Mar. 30, 2017

(54) MODULAR ADULT TOY

(71) Applicant: Timothy Daniel HUTCHISON, Thornlands (AU)

(72) Inventor: Timothy Daniel HUTCHISON, Thornlands (AU)

(21) Appl. No.: 14/869,623

(22) Filed: Sep. 29, 2015

(51) Int. Cl. A61H 19/00; A61H 23/00

(52) U.S. Cl. CPC A61H 19/00; A61H 23/00; A61H 19/40; A61H 19/30; A61H 2205/087

(57) ABSTRACT

The modular adult toy includes a base module with a housing having a first connection half at one end; and at least one shaft module. Each shaft module includes a body having a second connection half at one end and a first connection half at an opposite end. There is a head module having a body having a second connection half at one end. Each of the first connection halves are configured to be releasably connectable with any second connection half.

### CROSS-REFERENCE TO RELATED APPLICATIONS

See the Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OM MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

The present invention relates to a modular adult toy. More particularly, the present invention relates to an adult toy that is modular and configurable.

2. Description of Related Art Including Information Disclosed Under 37 CFR 1.97 and 37 CFR 1.98.

Adult sex toys have become increasingly popular for individuals, couples or similar. One of the more common types is the vibrator, which has a power source and a vibrating unit connected to a shaft. More sophisticated types may also have a clitoral stimulator that extends to one side of the main shaft. Toys of this type are generally of a single shape and size, and a user or users are required to buy either a single toy that may meet most, but not necessarily all, of their needs, or buy a range of toys for different moods and scenarios.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a modular adult toy, comprising:
a base module comprising a housing having a first connection half at one end; and
at least one shaft module, each shaft module comprising a body having a second connection half at one end and a first connection half at an opposite end;
a head module comprising a body having a second connection half at one end; and
each of the first connection halves are configured to be releasably connectable with any second connection half.

In a preferred embodiment, the housing of the base module has a flat base.

In another preferred embodiment, the housing of the base module further comprises a suction cup.

In another preferred embodiment, the housing of the base module further comprises a first connection half at an opposite end thereof.

In another preferred embodiment, the housing that forms the base module is shaped to be grasped by a user to position and move the toy in use.

In another preferred embodiment, the base module further comprises user controls.

In another preferred embodiment, the user controls are a Bluetooth receiver, a wireless receiver or infrared receiver.

In another preferred embodiment, the base module further houses a power source.

In another preferred embodiment, the power source is rechargeable.

In another preferred embodiment, an external side wall of the base module is substantially smooth.

In another preferred embodiment, an external side wall of the base module further comprises micro-vibrators.

In another preferred embodiment, the shaft module has a smooth outer surface.

In another preferred embodiment, an external side wall of the shaft module further comprises micro-vibrators.

In another preferred embodiment, the shaft module further comprises a power source.

In another preferred embodiment, the body of the head module has a tapered end located opposite to the second connection half.

In another preferred embodiment, the body of the head module is generally conical.

In another preferred embodiment, the body of the head module is rounded and/or bulbous.

In another preferred embodiment, and external side wall of the shaft module further comprises micro-vibrators.

In another preferred embodiment, the first and second connection pair parts comprise mutually connecting male and female screw threads.

In another preferred embodiment, the first and second connection pair parts comprise a bayonet mount.

In another preferred embodiment, the first and second connection pair parts comprise a push-fit click together attachment.

In another preferred embodiment, the first and second connection pair parts comprise a friction-fit connection.

In another preferred embodiment, the base module further comprises a vibration mechanism.

In another preferred embodiment, the modular adult toy further comprises a remote control.

In another preferred embodiment, the micro-vibrators are in the shape of one or a combination of ribs, nodes, hemispherical balls, protrusions or similar.

In another preferred embodiment, the shaft module and head module further comprise a vibration mechanism.

In another preferred embodiment, a cross-section shape of the shaft module is substantially circular or oval.

In another preferred embodiment, the head module has the shape of one or more of a conical head unit, a G-spot head unit, a bullet shaped unit, a bell shaped unit, a multiple shaped head and an egg shaped head.

In another preferred embodiment, an external side wall of the shaft module is textured, profiled or shaped.

In another preferred embodiment, an external side wall of the shaft module includes ribs, ridges, pearls, or nodules.

In another preferred embodiment, an external side wall of the shaft module includes a studded texture, a small ribbed texture, a large ribbed texture or a vein feature texture.

In another preferred embodiment, an external side wall of the head module is textured, profiled or shaped.

In another preferred embodiment, the widths of the modules differ.

In another preferred embodiment, the modular adult toy further comprises two or more shaft modules.

In another preferred embodiment, the shaft modules comprise differing external side wall texture, side wall shapes, length and/or thickness.

In another preferred embodiment, the modular adult toy further comprises two or more head modules.

In another preferred embodiment, the head modules comprise differing external side wall texture, side wall shapes, length and/or thickness.

In another preferred embodiment, the base module and the shaft module comprise electrical connectors to allow electrical connection between the modules.

In another preferred embodiment, the shaft module and the head module comprise electrical connectors to allow electrical connection between the modules.

In another preferred embodiment, the base module and/or the shaft module comprises appendage additions.

In another preferred embodiment, the appendage additions comprise a clitoral stimulator, an anal stimulator, or a combination thereof.

In another preferred embodiment, the position of the clitoral stimulator and/or the anal stimulator along the toy can be adjusted.

In another preferred embodiment, the clitoral stimulator and/or the anal stimulator comprise a vibration means.

In another preferred embodiment, the shaft module comprises two or more separate branches, each branch having a first connection half.

In another preferred embodiment, the head module comprises a rotating head module.

In another preferred embodiment, the shaft module is configured as a hollow module.

In another preferred embodiment, the modular adult toy further comprises a combined power source and vibrating unit, the unit being removably received in an internal hollow section within at least one of the base module, the shaft module and the head module.

In another preferred embodiment, the combined power source and vibrating unit comprises a rechargeable power source and at least one vibrator housed within a casing.

In another preferred embodiment, the unit is controllable via a remote control.

In another preferred embodiment, the unit comprises an alarm to indicate low power source charge.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 is a schematic side view of an assembled adult toy in accordance with a first preferred embodiment of the present invention, the adult toy made up of a base module, a shaft module and a head module.

FIG. 2 is a schematic side view of a base module according to a second embodiment of the invention.

FIG. 3 is a schematic side view of a shaft module according to a second embodiment of the invention.

FIG. 4 is a schematic side view of a head module according to a second embodiment of the invention.

FIG. 5 is a schematic side view of two modules, showing a first embodiment of a connection means between the two modules being a bayonet mount.

FIG. 6 is a schematic side view of two modules, showing a second embodiment of a connection means between the two modules being threaded formations.

FIG. 7 is a schematic side view of two modules, showing a third embodiment of a connection means between the two modules being a click-lock formation.

FIG. 8 shows a schematic view of a number of the shaft modules of FIG. 3 connected end-to-end.

FIG. 9 shows a schematic view of an alternative form of base module having electrical contacts and a suction cup fitted to attach the base module to a surface.

FIG. 10 is a schematic perspective view of a shaft module with electrical contacts.

FIG. 11 shows a schematic view of an alternative form of base module.

FIG. 12 is a perspective view of the base module of FIG. 2 with a remote control.

FIG. 13 shows schematic views of possible variations of the head module in shape and/or size.

FIG. 14 shows schematic views of possible variations of the shaft module in side wall textures.

FIG. 15 shows schematic views of possible variations of the shaft module in appendage features.

FIG. 16 shows a cross-section view of an assembled embodiment with an alternative battery and vibration unit.

FIG. 17 shows schematic views of additional alternative assembled embodiments of adult toys and a remote control unit.

### DETAILED DESCRIPTION OF THE INVENTION

It should be noted in the following description that like or the same reference numerals in different embodiments denote the same or similar features. For example, in the description below, variations of the same part are denoted by the same numeral followed by a suffix that denotes the specific or particular variant. When the part is referred to in the general (that is, referring to any or all of the variations), then the reference numeral is used without a suffix.

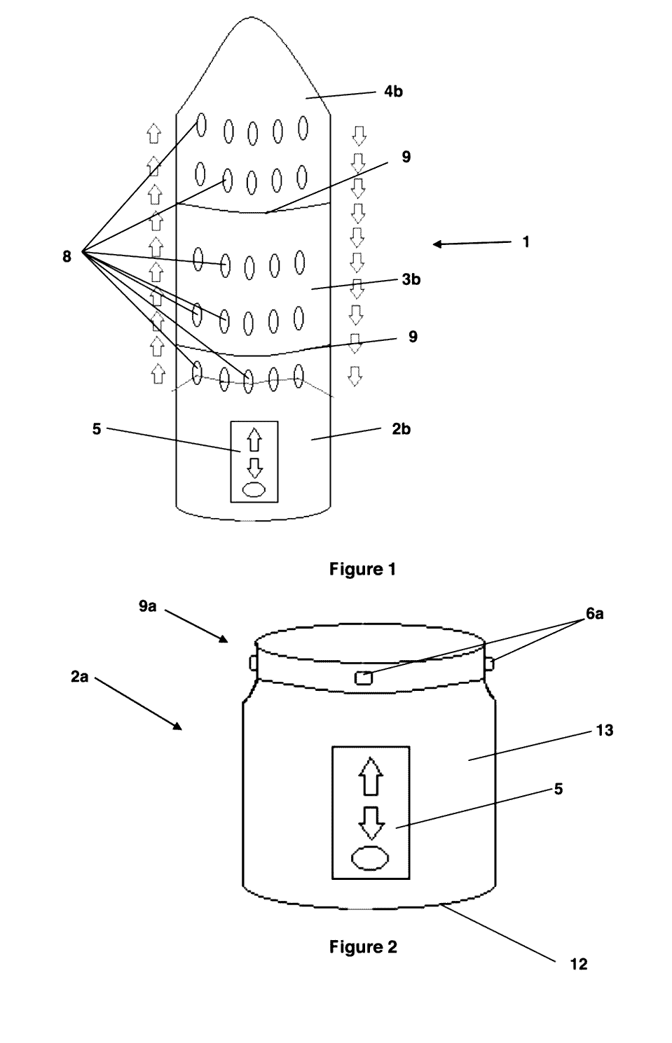

An embodiment of the adult toy 1 of the present invention is shown in FIG. 1. The adult toy 1 is modular to allow a user or users to configure their own preferred version by joining a number of modules together. The preferred embodiment of adult toy 1 of the present invention has three main types of modular component, which are connectable together in series in various configurations to produce a toy configured as required or desired. These three main modular components are: a base module 2, a shaft module 3 and a head module 4 described below, which are connectable to each other via connection means 9.

An initial preferred embodiment of the present invention will initially be described with reference to FIGS. 2 to 5. There are many possible variations to the present invention, and some of these possible variations will be described below after the first embodiment.

Base Module

One preferred embodiment of the base module 2a of the present invention is shown in FIG. 2. The base module 2a comprises a housing generally having the form of a cylindrical section with a flat base 12 at one end, an external side wall 13, and a first half 6a of a connection means 9a at the opposite end. The connection first half part 6a will be described in detail below.

A vibration mechanism such as an electric motor or motors with an offset weight are housed within the base module 2a, along with a power source such as a battery. User controls 5 are mounted on the side wall 13, which are used to turn the toy on and off (that is, turn the vibration mechanism(s) on and off), and which a user can use to control at least the speed and preferably also the pattern of vibration of the toy 1 (that is, the speed, rhythm, pattern and intensity of the vibrations). The power source is rechargeable by plugging the base module 2a in to a wall socket or via induction. The power source can also be standard disposable batteries. The base module 2a could also be controlled via a Bluetooth or wireless remote control 30 to allow the toy 1 to be remotely controlled (see FIG. 12).

Shaft Module

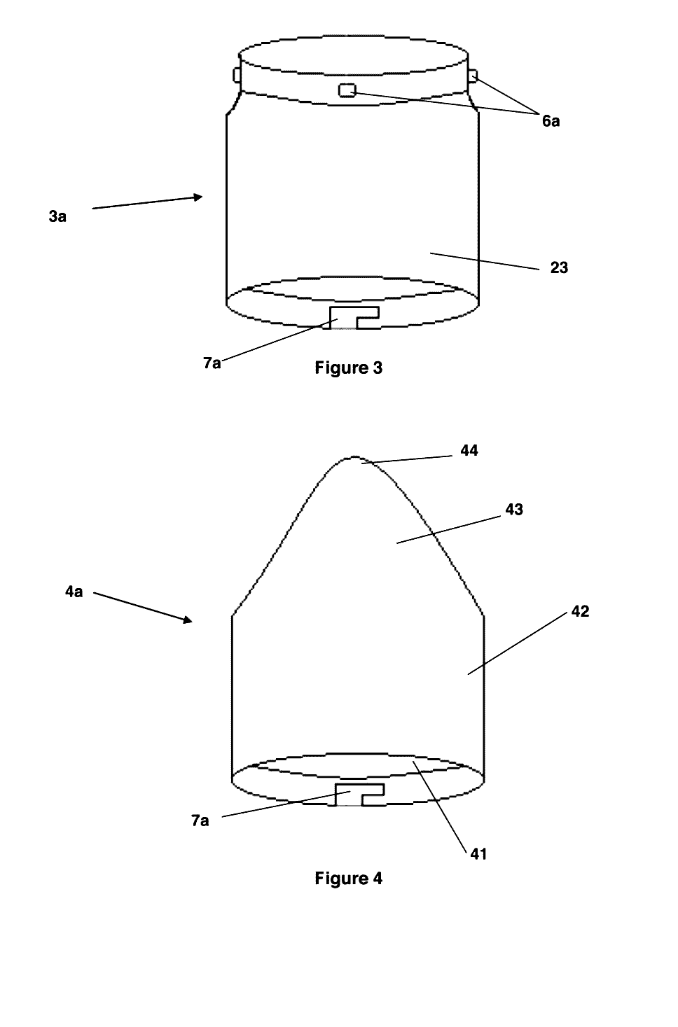

An embodiment of a shaft module 3a is shown in FIG. 3. The shaft module 3a also has a generally cylindrical body with a connection first half part 6a (identical to that used on the base module 2a) at one end, a side wall 23 and a connection second half part 7a at the opposite end.

The connection first half 6a on the base module 2a can mate with the connection second half part 7a in the shaft module 3a, so that the shaft module 3a extends from the base module 2a.

Referring to FIG. 5, the connection means 9a comprises a bayonet mount formed by the connection first half 6a and the connection second half 7a. The connection first half part 6a comprises a cylindrical male formation with radial pins. The connection second half 7a comprises a female receptor with matching L-shaped slots. The pins are pushed into the open section of the L shaped slot, and are then slid across the closed section of the L shaped slot. The bayonet mount may also include a spring to keep the two parts locked together. The connection means 9a thus provides a quick releasable connection.

In the embodiment as shown in FIG. 3, the shaft module 3a has a smooth outer surface.

Head Module

An embodiment of the head module 4a is shown in FIG. 4. The head module comprises a body having a base end 41, a cylindrical side wall portion 42 and a conical side wall portion 43 which terminates to a rounded upper end 44.

A connection second half 7a is formed on the base end 41 so that the head module 4a can be connected to a connection first half 6a, such as that on one end of the shaft module 3a, or that on the base module 2a.

Use

The base module 2a, shaft module 3a, and head module 4a are thus connectable to each other to form an adult toy similar to the adult toy 1 of FIG. 1. The user can then use the controls 5 for the adult toy to function as desired.

Connection Means

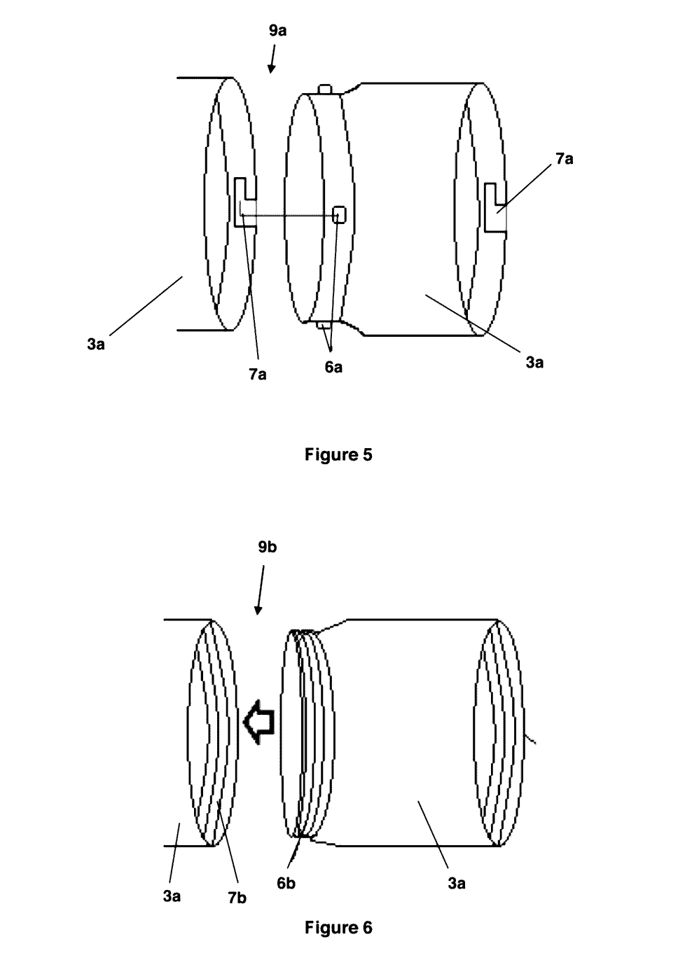

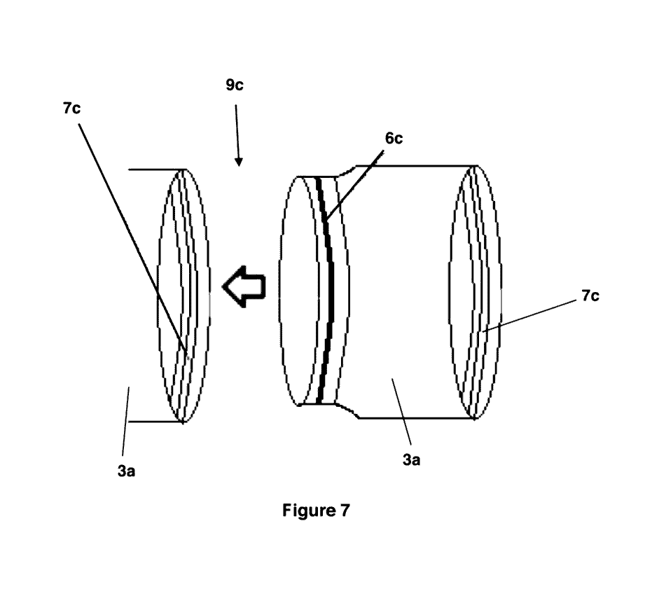

The connection means 9 comprises first and second halves 6 and 7 that releasably mates in use so that together they form a releasably connected whole connection pair. Several different connection means 9 are suitable including but not limited to the following:
connection means 9a being a bayonet mount as shown in FIG. 5,
connection means 9b shown in FIG. 6 comprising mutually connecting male and female screw threads 6b, 7b—where one module will have the male thread 6b and the other module will have the corresponding female threaded socket 7b,
connection means 9c shown in FIG. 7 comprising a push-fit click attachment—where one module comprises a protruding peripheral ridge 6c whilst the other module comprises a socket with an internally formed peripheral groove 7c, or
a friction-fit connection can also be used, or any other suitable connection mechanism.

Variations

In another embodiment as shown in FIG. 1, the side walls of the base module 2b, shaft module 3b and head module 4b include a number of micro-vibrators 8. These micro-vibrators 8 can have the shape of one or a combination of ribs, nodes, hemispherical balls, protrusions or similar.

The shaft module 3b and head module 4b in FIG. 1 can further comprise a vibration mechanism or at least a connection mechanism that connects to the vibration mechanism in the base module 2b. When activated by a user, the vibration mechanism (in either the base 2, the shaft module 3b and/or the head module 3b) operates the micro-vibrators 8 so that they move and vibrate. Similar vibration mechanisms can be included on the base module 2b. This would allow a vibration to pass in a pattern up and down and/or around the full length of the toy 1 in use (as indicated in the arrows in FIG. 1), or the same or varying levels of intensity, speed and rhythm. For example, the micro-vibrators 8 could be programmed to start vibrating at the base of the shaft, moving upwards. On reaching the top of the shaft the vibration pattern moves back down the shaft to the base.

In this context, ‘generally cylindrical’ does not mean that the shaft module 3 has to be substantially circular in cross-section: the shaft module could be circular, oval or a similar regular shape in cross-section. A generally rounded cross-section with no corners is preferred, but a cross-sectional shape with corners (e.g. hexagonal) is not excluded from the scope of the invention.

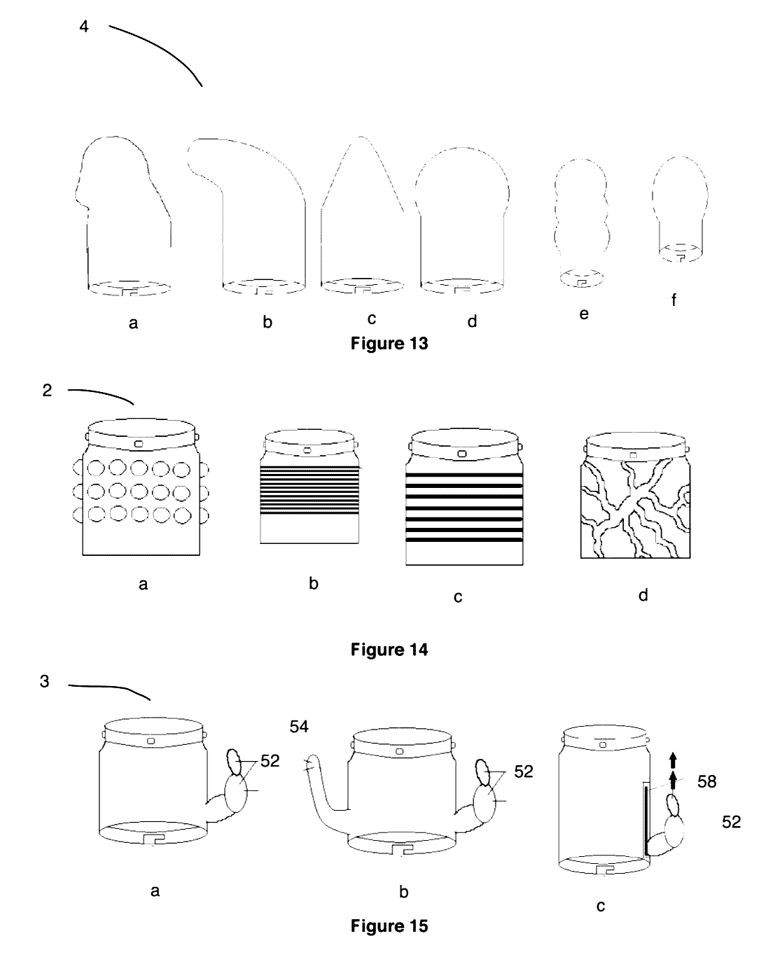

The head module 4 can be shaped and/or sized as desired. Examples of possible variations thereto are shown in FIG. 13, which (from left to right) includes (a) a head unit, (b) a G-spot head unit, (c) a bullet shaped unit, (d) a bell shaped unit, (e) a multiple shaped head and (f) an egg shaped head. The head module 4 can also be rounded and/or bulbous, or could have a novelty shape such as an animal head, superhero head, politicians or celebrities head, clenched first or similar.

The side walls of the base module 2a, shaft module 3a and head module 4a in the embodiment described above are generally smooth. The side walls of the modules 2, 3, 4 can alternatively be textured, profiled or shaped. For example, the side walls can include ribs, ridges, pearls, nodules or similar extending therefrom.

Examples of possible variations to the side wall texture and features are shown in FIG. 14, which (from left to right) includes (a) a studded texture, (b) a small ribbed texture, (c) a large ribbed texture and (d) a vein feature texture. The examples are shown in a base module, but are equally applicable to the shaft and head modules.

The width profiles within one module can also be varied. For example, a module can have tapering or diverging side walls, or hour glass shaped side walls.

The widths of the base module, shaft module and head modules in one adult toy can also be varied. Preferably, a smooth transition is provided between the module side walls at the connection means junctions.

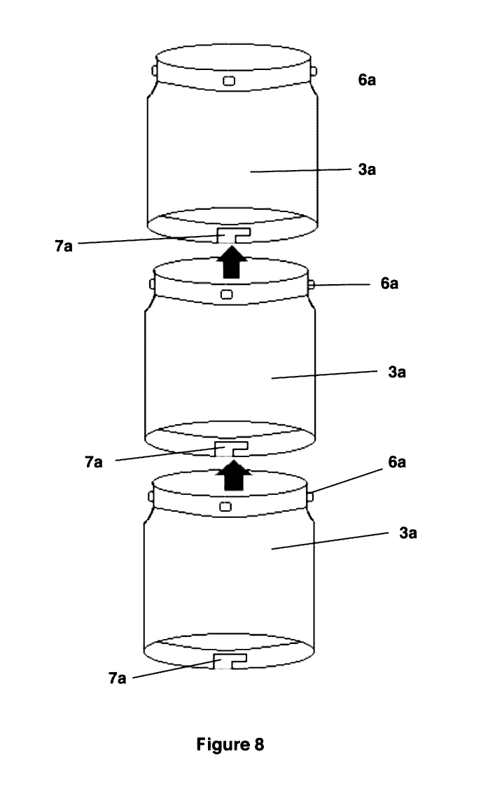

The customised adult toy 1 can also include two or more shaft modules 3 that are connected end-to-end to increase the overall length of the toy 1, as shown in FIG. 8. These modules can be ‘mixed and matched’ to include a mix of shaft modules with smooth surfaces, ribbed surfaces, vibrating modules, varied shapes, etc.

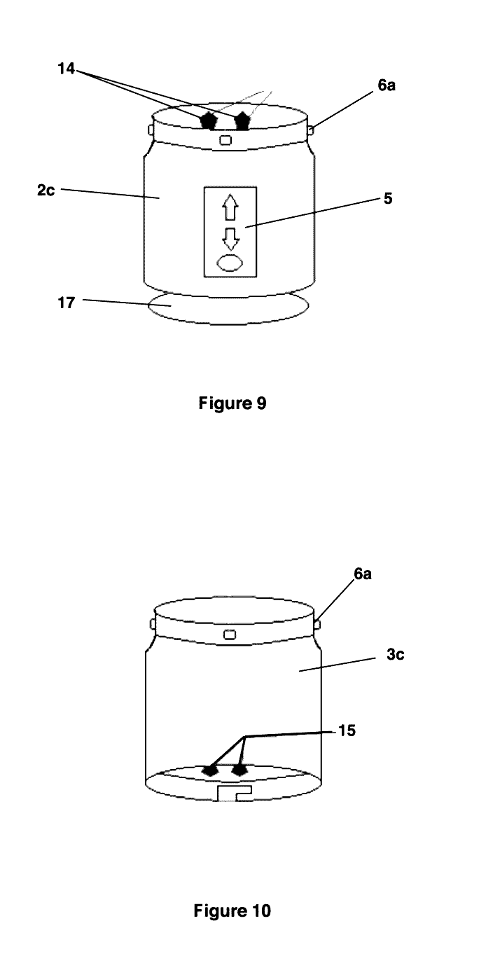

The base module 2, and at least the shaft module 3 and potentially the head module 4 can be fitted with connectors to allow electrical connection between the components. An embodiment of a base module 2c with electrical connectors 14 is shown in FIG. 9, and an embodiment of a shaft module 3c with electrical connectors 15 is shown in FIG. 10. These electrical connectors 14 and 15 are formed with the connection means 9 and connect when the connection means are joined. The electrical connectors allow the power source or battery in the base module 2 to provide power to the vibrators in the shaft module 3, and the head module 4 if necessary.

The base module 2c shown in FIG. 9 also shows a variation in that it is fitted with a base suction cup 10. The suction cup 10 can be used to keep the adult toy 1 stationary or mounted to a surface in use or for storage. As described above, the base module 2a has a flat base to allow it to stand on a surface. As shown in FIG. 9, in a variation, the base module 2c can be fitted with a suction cup to allow the base module (and thus the toy 1) to be attached to a surface.

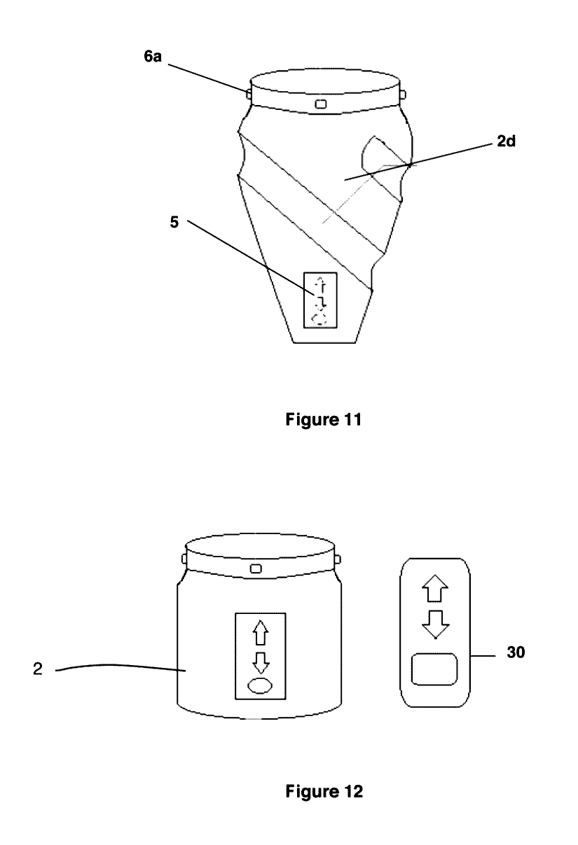

As shown in FIG. 11, in a further variation, the base module 2d can be ergonomically shaped to be grasped by a user in use to position and move the toy 1. The base module 2b is generally frusto-conically shaped which allows easy grasping by the user.

The base module 2 could also be shaped like the various designs of the head module 4 to enable the toy 1 to be turned into a double-sided or double-ended adult toy or vibrator. The base module 2 can also include a connection half at its base end, such that a shaft module and/or head modules can be attached to both ends of the base module to provide a double ended adult toy. If the adult toy does not include a vibration means, the toy is configured as a dildo.

FIG. 15 shows a shaft module with possible appendage additions. These appendage additions, for example (from left to right) can include (a) a clitoral stimulator 52 (which can include a vibrator), (b) an anal stimulator 54 and a clitoral stimulator 52 (which can both include a vibrator), and (c) a clitoral stimulator 53 movable along the length of the shaft module (along track 58) as required by the user for maximum or minimum contact with the clitoris. The anal stimulator 54 can also be made movable to provide various contact or penetration depth as desired. These appendage additions can also be added to the base module 2 and the head module 4 as desired. The appendage additions can also have a flexible connection to the shaft/base module such that their position and orientation can be adjusted or modified.

The design of the adult toy 1 and its possible variations outlined above will allow users to have multiple sex toys by attaching the various modules in different combinations as desired, thus eliminating the need to go out and purchase a whole lot of sex toys when they get bored of their old toys. This is also more cost effective as they will only need to purchase a single component to alter the design of the toy thus making their investment in the modular sex toy sustainable given the adaptability of the design.

The design will also allow the user to charge the base or shaft module (whichever houses the power source) separately from the other components and thus be more discreet. The toy 1 is also more compact when disassembled as the components are detachable and this will allow the user to more easily store the toy.

The various modules are available in different designs, colours, sizes, textures, and materials (i.e. colour, colour changing, heating, plastic or silicone etc.)

Whilst preferred embodiments of the present invention have been described, it will be apparent to skilled persons that other modifications can be made to the embodiments described.

Other possible variations include a shaft module with two or more separate branches, to which a user can add further shaft modules or head modules. The head module can also be a rotating head module. Also, the shaft module can be configured as a hollow module and a series of such modules can be used to form a vibrating tube for use by males. The feel and texture of the inner surface of such a tube can then be customised as desired in a similar manner to the above. A similar unit can be provided that does have a vibrating mechanism or remote control making it a variable dildo or dong.

The base, shaft or head modules can also be customised by providing a sleeve, such as a silicone sleeve, that fits over the adult toy to alter or vary the textures, width, size, etc.

The base, shaft or head modules can also be customised by making one or more modules having at least an inflatable portion to vary the girth or diameter of the toy.

The adult toy can also be made from a plain plastic material that does not have varied textures but may have varied shapes. The adult toy can have a single vibrator only or be powered by disposable standard batteries.

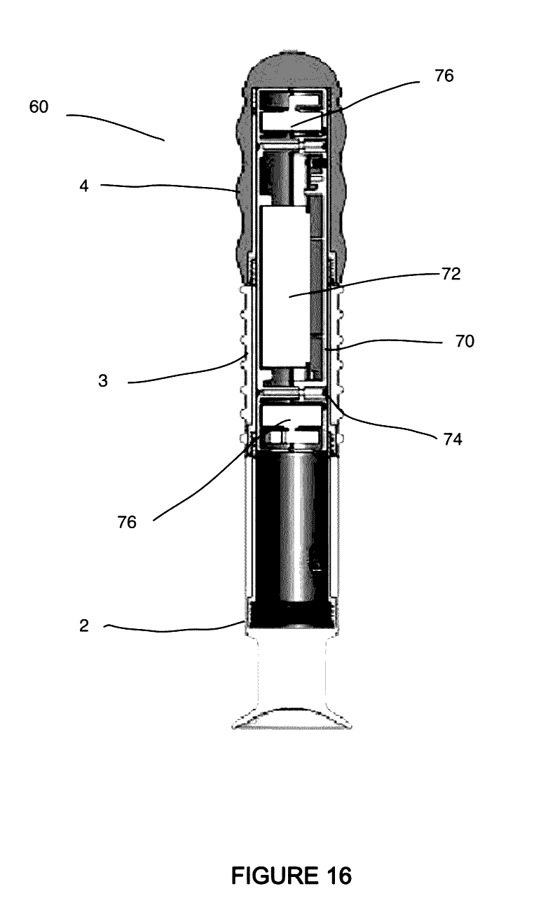

FIG. 16 shows another embodiment of an assembled adult toy 60 according to the present invention which also has a base module 2, a shaft module 3 and a head module 4 which are connectable to each other. Each of the base module 2, shaft module 3 and head module 4 is hollow and the hollow sections interconnect.

This embodiment comprises a combined power source and vibrating unit 70 which is removable. The unit 70 comprises a rechargeable power source (battery) 72 which is housed in the centre of a round plastic casing 74. Vibrators 76 are provided at each end of the battery 72 within the casing 74, and powered by the battery 72.

The unit 70 is received in the hollow sections of two modules (e.g. head and shaft, or base and head, etc.). Alternatively, the unit 70 can be sized to be received in one module only. An assembled adult toy can also receive more than unit 70. The unit 70 is received in a tight fit within the hollow sections and is removable when the modules are disconnected.

The power source has an on/off button to stop the battery from draining when not in use and also has an audible alarm that will sound when the battery reaches a set low voltage to notify the user that it needs to be recharged.

There is a circuit board housed within the power source/vibrating unit 70 that allows the vibrators to be turned on and allows the vibrating pattern to be changed. The preferred embodiment unit has seven different vibrating functions which can be used and cycled through by using a wireless remote.

The power source and vibrating assembly 70 is designed to be removable so that the user can charge it without having the sex toy visible to anyone. The power source and vibrating unit 70 will appear like an elongated battery only with a generic or plain casing. This embodiment also allows the user to clean the adult toy 60 modules without worrying about water and the electric parts. The assembly 70 can be charged using a standard micro USB connection or via an induction dock.

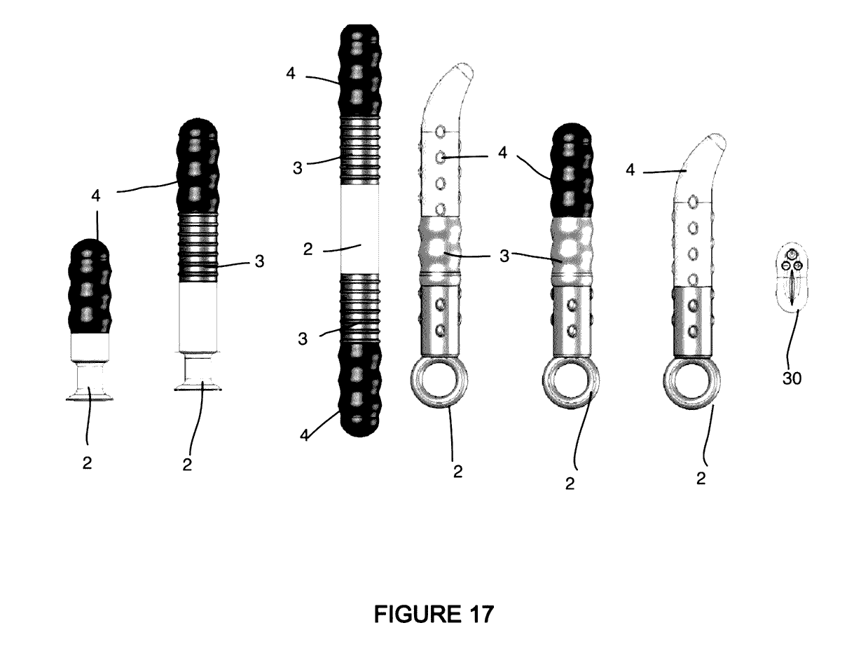

FIG. 17 shows various embodiments of the present invention including (from left to right)
(a) a suction cup base module 2 and a head module 4,
(b) a suction cup base module 2, a shaft module 3 and a head module 4,
(c) a double ended toy having a cylindrical base module 2, a shaft module 3 at each end of the base module 2 and a head module 4 connected to each shaft module 3,
(d) a ring grip base module 2, a ribbed shaft module 3, a studded shaft module 3, and a G spot head module 4,
(e) a ring grip base module 2, a ribbed shaft module 3 and a ribbed head module 4,
(f) a ring grip base module 2, a studded shaft module 3 and a G spot head module 4,
(g) a remote control unit 30.

The present embodiments thus provide an adult toy which is rechargeable, waterproof, totally customizable, includes a low battery alarm, includes a wireless remote that allows on/off and cycle through vibration modes and power, easy and discreet to clean and low cost.

1. A modular adult toy, comprising:
a base module comprising a housing having a first connection half at one end;
at least one shaft module, each shaft module comprising a body having a second connection half at one end and a first connection half at an opposite end; and
a head module comprising a body having a second connection half at one end, wherein each first connection half is configured to be releasably connectable with any second connection half.

2. The modular adult toy, as claimed in claim 1, wherein said housing of said base module further comprises a first connection half at an opposite end thereof.

3. The modular adult toy, as claimed in claim 1, further comprising: micro-vibrators on an external side wall of one of a group consisting of said base module and said shaft module.

4. The modular adult toy, as claimed in claim 1, wherein the first and second connection halves comprise at least one of a group consisting of: corresponding male and female screw threads, bayonet mount formations, and a friction-fit connection.

5. The modular adult toy, as claimed in claim 1, further comprising: a vibration mechanism contained within one of a group consisting of: said base module, said shaft module, and said head module.

6. The modular adult toy, as claimed in claim 5, further comprising a remote control for controlling the vibration mechanism.

7. The modular adult toy, as claimed in claim 1, wherein said shaft module has a cross-section with a shape comprised of one of a group consisting of: substantially circular and oval.

8. The modular adult toy, as claimed in claim 1, wherein said head module has a shape comprised of at least one of a group consisting of: a conical head unit, a G-spot head unit, a bullet shaped unit, a bell shaped unit, a multiple shaped head and an egg shaped head.

9. The modular adult toy, as claimed in claim 1, further comprising: an external side wall of one of group consisting of said shaft module said head module, said external side wall being one of group consisting of: textured, profiled and shaped.

10. The modular adult toy, as claimed in claim 1, wherein said shaft module has an external side wall having one of a group consisting of: a studded texture, a small ribbed texture, a large ribbed texture, and a vein feature texture.

11. The modular adult toy, as claimed in claim 1, wherein widths of the modules differ.

12. The modular adult toy, as claimed in claim 1, further comprising an additional module, said additional module being one of a group consisting of another shaft module and another head module.

13. The modular adult toy, as claimed in claim 12, wherein said additional module differs from said shaft module and said head module in at lease one of a group consisting of: external side wall texture, side wall shapes, profiles, length and thickness.

14. The modular adult toy, as claimed in claim 1, further comprising: an appendage addition, each appendage addition being comprised of at least one of a group consisting of: a clitoral stimulator, and an anal stimulator, each appendage addition being attached to one of a group consisting of: said base module and said shaft module.

15. The modular adult toy, as claimed in claim 14, wherein said appendage addition is adjustable in position relative to said base module.

16. The modular adult toy, as claimed in claim 14, further comprising: a vibration means attached to said appendage addition, said appendage addition being one of group consisting of: clitoral stimulator and anal stimulator.

17. The modular adult toy, as claimed in claim 1, wherein said shaft module comprises two or more separate branches, each branch having a first connection half.

18. The modular adult toy, as claimed in claim 1, further comprising: a combined power source and vibrating unit, said vibrating unit being removably received in an internal hollow section within at least one of a group consisting of: said base module, said shaft module and said head module.

19. The modular adult toy, as claimed in claim 18, wherein the combined power source and vibrating unit comprises a rechargeable power source and at least one vibrator housed within a casing.

20. The modular adult toy, as claimed in claim 18, wherein said vibrating unit comprises an alarm to indicate low power source charge.
